(19) United States
(12) Patent Application Publication
(10) Pub. No.: US 2002/0055928 A1
(43) Pub. Date: May 9, 2002

(54) Methods and apparatus employing multi-tier de-coupled architecture for enabling visual interactive display

(75) Inventor: Jeffrey L. Worthington, Harleysville, PA (US)

Correspondence Address: Harold H. Fullmer, Woodcock Washburn Kurtz, Mackiewicz & Norris LLP, One Liberty Place - 46th Floor, Philadelphia, PA, 19103, US

(73) Assignee: iMedium, Inc.

(21) Appl. No.: 09/885,788

(22) Filed: Jun. 20, 2001

Related U.S. Application Data
(60) Provisional application No. 60/213,205, filed on Jun. 21, 2000.

(51) Int. Cl. G06F 17/00

(52) U.S. Cl. 707/102

(57) ABSTRACT

Open scalable architecture or infrastructure is provided that includes decoupled tiers that collectively transform data into information and then into content, and then finally into visual interactions creating an engaging user experience. The architecture enables ad hoc or directed decoupling of tiers allows for reuse at level above plain content: business rules, presentation rules, declared interactions, event reporting, and content and information assets may all be cached and reused as needed. The architecture manages the integration of multiple data sources into semantically rich markup for driving effective visual interactions. The architecture further enables integration points at each tier for maximum partner interoperability, and the decoupled tires allow for separate scalability at each level. The system is customizable using one of several templates. A partner or customer can prepare its data according to the particular template, thereby eliminating or substantially diminishing the amount of custom-programming.

This application claims priority under 35 U.S.C. § 119(e) to U.S. Provisional Patent Application Serial No. 60/213,205, which was filed on Dec. 11, 1998 and is hereby incorporated by reference in its entirety.

### BACKGROUND OF THE INVENTION

This invention relates to computer architecture and related functionality thereof.

Networks, such as the world wide web, connect powerful multimedia computers over the global Internet, which many organizations have successfully leveraged to present textual and graphical content to end users to achieve their e-business objectives. These browser-based applications can be media-rich and attractive, and many platforms now exist to dynamically generate them from enterprise data sources. Some companies have tried to extend the concept further, using the Web as the foundation of a long-sought goal—namely rich, distributed applications linking users across enterprise boundaries. However, the Web has fallen far short of being able to effectively deliver enterprise-to-enterprise (E2E) applications. First, browser-based user interactions are insufficient for E2E. Even the addition of client-side scripting, plug-ins, media players, and Java applets has not solved the problem. While allowing some dynamic interaction on the client side, these add-on technologies cause more problems, in the form of instability, incompatibility, and deployment issues, than they solve.

Besides these client-side problems, the Web-based approach to E2E also fails to adequately address data integration issues. Such architectures typically require specialized replication feeds to dedicated systems serving the applications. Electronic Data Interchange (EDI) and Extensible Markup Language (XML) promise integration, but these pipes strip data of too much semantic value. They fall short of being able to convey business rules for interaction with or presentation of an enterprise's information assets.

It was within this context that the present inventors realized the need for an architecture that would take advantage of the ubiquitous network and the multimedia capabilities of the connected computers while preserving the enterprise-specific semantics of the information to be presented. This new architecture would have to address the limitations of current alternatives by being:

Easy and inexpensive to deploy

Information- and content-driven rather than hard-wired

Quickly adaptable

Highly interactive

Collaborative within and among enterprises

Versatile and well-enough encapsulated to be either hosted or installed

Scalable and horizontally ubiquitous

Co-pending U.S. patent application Ser. No. 09/553,440, filed Apr. 19, 2000, entitled “Method and Apparatus for Dynamically Generating Enabled Electronic Content,” describes aspects of advertising content and e-commerce transaction platform for allowing interaction with a visual display. Such a system provides several advantages, but often requires customized programming to provide the requisite advertising data in response to the user's interaction. The present invention is generally directed to make a visual interaction system (of any type) more robust by providing a “template” and scalable processing functions that make it easier to develop interactive visual displays.

### SUMMARY

The growing global network of increasingly powerful computers enables enterprises to forge new kinds of connections. Organizations are discovering powerful ways to leverage this network to interact with their constituents. Increasingly, these innovative enterprise-to-enterprise (E2E) applications will exploit the effectiveness and intuitiveness of visual interactions. Many of the necessary conditions are in place, but several obstacles still exist.

The invention provides a new approach to the challenge by employing the methods and architecture described herein. An open, scalable system is provided that is customizable using one of several templates. A partner or customer can prepare its data according to the particular template, thereby eliminating or substantially diminishing the amount of custom-programming. The architecture described herein is generally referred to by the term nTierActive (TM) infrastructure.

The nTierActive (TM) architecture or infrastructure of the present invention includes decoupled tiers that collectively transform data into information and then into content, and then finally into visual interactions creating an engaging user experience. The architecture enables ad hoc or directed deployment of the client-side container and, separately, of content and applications. The decoupling of tiers allows for reuse at a level above plain content: business rules, presentation rules, declared interactions, event reporting, and content and information assets may all be cached and reused as needed.

nTierActive (TM) manages the integration of multiple data sources into semantically rich markup for driving effective visual interactions. The architecture enables integration points at each tier for maximum partner interoperability, and the decoupled tiers allow for separate scalability at each level.

### BRIEF DESCRIPTION OF THE FIGURES

FIG. 1 is a schematic diagram of the architecture of the present invention, showing the information asset tier, the content asset tier, and the application asset tier mutually de-coupled, and de-coupled from the client. The arrows indicate information input/output that is in XML format.

FIG. 2 is a view of a visual interaction client that may be easily deployed.

FIG. 3 is chart illustrating flow according to the present invention relative to each tier illustrated in FIG. 1.

FIG. 4 is a chart illustrating functionality of each tier, including corresponding development tools and personnel.

### DESCRIPTION OF PREFERRED EMBODIMENTS

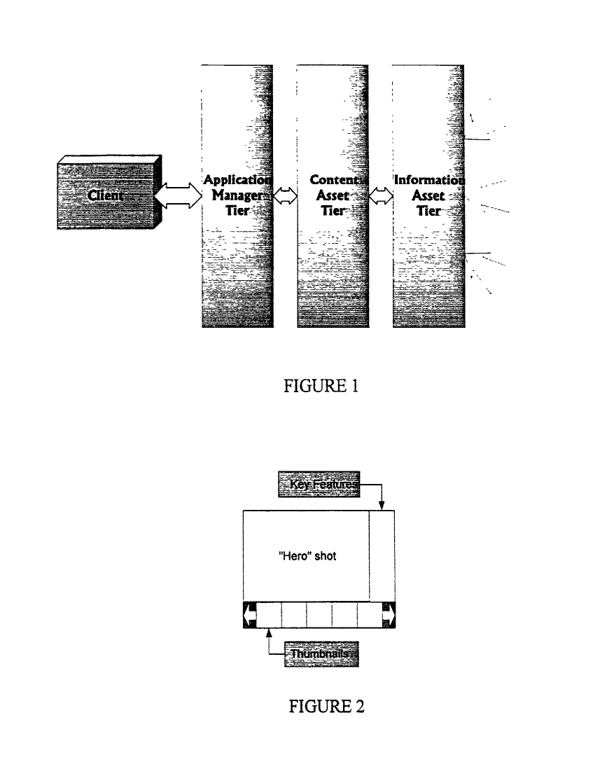

As shown in FIG. 1, the architecture of the present invention includes an information asset tier, a content asset tier, and an application manager tier that interact with a client.

Information Asset Tier

Information assets define references to data sources within the nTierActive (TM) hosted environment, or to external sources. External sources may be partner data feeds or XML documents, or third-party sources such as standards data. The information assets define any mapping or transformations required between the data sources and the nTierActive (TM) intermediate XML format. The intermediate format is not application-specific, and so these information assets are reusable across applications.

Content Asset Tier

Content assets refer to information assets, together with media assets, business rules, and enterprise semantics. The media assets may be pre-rendered images or references to server-side graphics generation services. Business rules may include presentation rules, interaction rules, and client access restrictions. Enterprise semantics come from the information assets, and assign additional enterprise-specific meaning to the content assets.

Application Manager Tier

An application is a use of the nTierActive (TM) technology to solve a class of business problems. An interaction style, layout template, and a set of event reporting and interaction rules define an application. An application manager is responsible for generating the XML that defines an application instance for the client, including references to media assets and event handling declarations. During an application session, the application manager handles events coming from clients, recording and/or responding to the events, and then may update the application state by publishing events to the clients.

Client

The visible front end to the nTierActive (TM) infrastructure is preferably an easily deployed, XML-based, generalized visual interaction client. The client is a Java-based container, not hard-wired to any particular application but capable of parsing the XML, rendering a visual interaction experience, and publishing interaction events up to the application manager.

Architectural Example

As an example of the use of the architecture of the present invention, a client may provide a results set that includes identifiers of products that refer to information given previously that was provided as data, usually by the partner. The term “partner” as used herein generally refers to an entity that provides or specifies the data input into the architecture (or the locations at which the data may be obtained) for displaying on the player. In an advertising or e-selling context, the partner may be a commercial merchant that, for example, may sell tools on a network such as the internet. In such a context, the result set may include a reference to a particular drill and a particular hammer of the partner. Based on the result set, the information asset manager may go to the data source for drills and pull out particular information and to the data source for hammers and pull out other, particular information. The content asset, based on what has been defined with respect to the product presentation XML, determines what is to be done with the information. For example, the content asset may contain instructions to render the product, its type and id, a manufacturer's specified attributes, and its key features.

A transformation based on product type, which is provided by the partner, indicates the key features for a drill (for example, voltage) and for a hammer (for example, head type and handle material). The data will be pulled into the information asset manager, which manages where to get the data and how often to refresh it. The partner/merchant selling a particular product provides a location for getting information for the particular product such that the information asset manager assembles such instructions, which are in XML or a similarly utilizable data integration language, and presents that set of instructions to the content asset tier. Such information could come from a third party or from any other source, including an external source (that is, data that is neither stored in the layers of the architecture nor in the partner's server). Alternatively, the data may be present on the information asset manager. Determining whether to store the information on the information asset manager or to get it on the fly is a cache and content freshness decision, and is not a limitation or a requirement of the architecture.

The content asset layer is then going to take that set of data—that is, this product presentation XML that is for this user session—and match it to any media assets that go with it. Thus, the content asset layer might look for partner's media assets for drills and hammers. Also, the content asset layer might locate and retrieve buying information, in which case it would execute a retrieval of pictures from an OEM's (original equipment manufacturer's) site or another site.

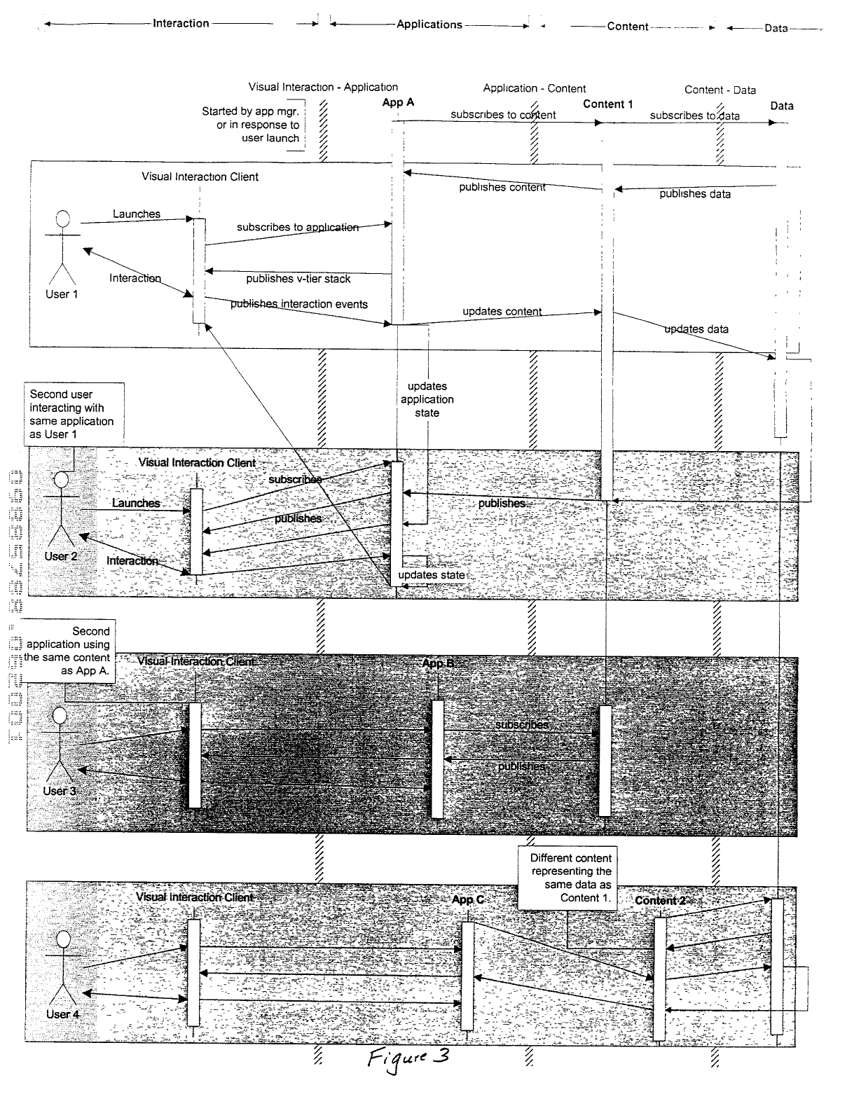

The application manager would then determine that particular layout of the regions of the visual interaction client for the appropriate kind of application. Thus, the application manager may take the media assets for all the products and put them across in a strip. Referring to FIG. 2, when one of the pictures in this product strip comes into focus, an enlarged photograph may then be used as the big picture in the upper left quadrant of the layout and media assets that present key features of the product may be used as the related content in the right upper quadrant of the layout. Meanwhile, for any additional XML information, for example a manufacturer's code, that would transform into the partner's name space, the application may pass it through, as well as any events reported on it. The external name space data is linked to that event. Later on, when the application publishes that data back to the partner, the partner will know that a particular event occurred for the particular manufacturer code.

Unlike other architectures, the architecture according to the present invention does not have to know anything about the way the partner's data is organized. None of the tiers of the present invention requires knowing how the data is organized (that is, its data model data-base schema). Rather, the present invention only requires that the data be represented in a certain way, such as in an XML format that corresponds to product type XML, which describes its own structure. Thus, the architecture may be distinguished from a database driven approach that would include an application server in the middle that talks to a database and would have to insert and organize all the products into a database and then retrieve and render them.

The independent scalability of each tier is an important feature of the manner of layering of the tiers of the present invention. Each of the tiers may produce XML in certain independently useful formats. Thus, the information asset management tier may be independent or de-coupled from the content asset management tier, which takes the information tier output and transforms it into the correct intermediate format and matches it with references to the media assets. The application manager is also independent (that is, decoupled) from the content asset management tier. This means, for example, that a partner's visual result set browser can be represented that uses different sets of content assets, which in turn, means that an individual tier may be scaled independently of other tiers, as needed. For example, if there are numerous hits on the application manager, the application manager tier may be scaled up independently to add additional capability to simultaneously initiate more multiple instances of a particular application (by, for example, adding additional hardware) without having to scale up the other tiers. In a conventional model of middle tier architecture, the entire architecture would be scaled up as a unit, and the efficiencies inherent in the discrete tier scalability enabled by the present invention would be lost.

Another feature of decoupled tiers is that it enables partners to configure their own content assets. Because it is an XML format that is published to them on the content asset manager tier, the partners can provide the results in an appropriate XML format right into the information asset manager tier, instead of by way of gateway.

Decoupling also means that the tiers may be operated such that static information assets can be pushed into a static cache that is placed between the information asset manager and content asset manager. Thus, in some circumstances the information asset manager may not need to be run at all as an executable program in that environment. Employing a static cache to disable the tier as an executable application may be applied at any of the points or tiers, including down to the player level where the player is consuming synchronized multimedia integration language (“smil”), which in the present circumstance could be a static smil.

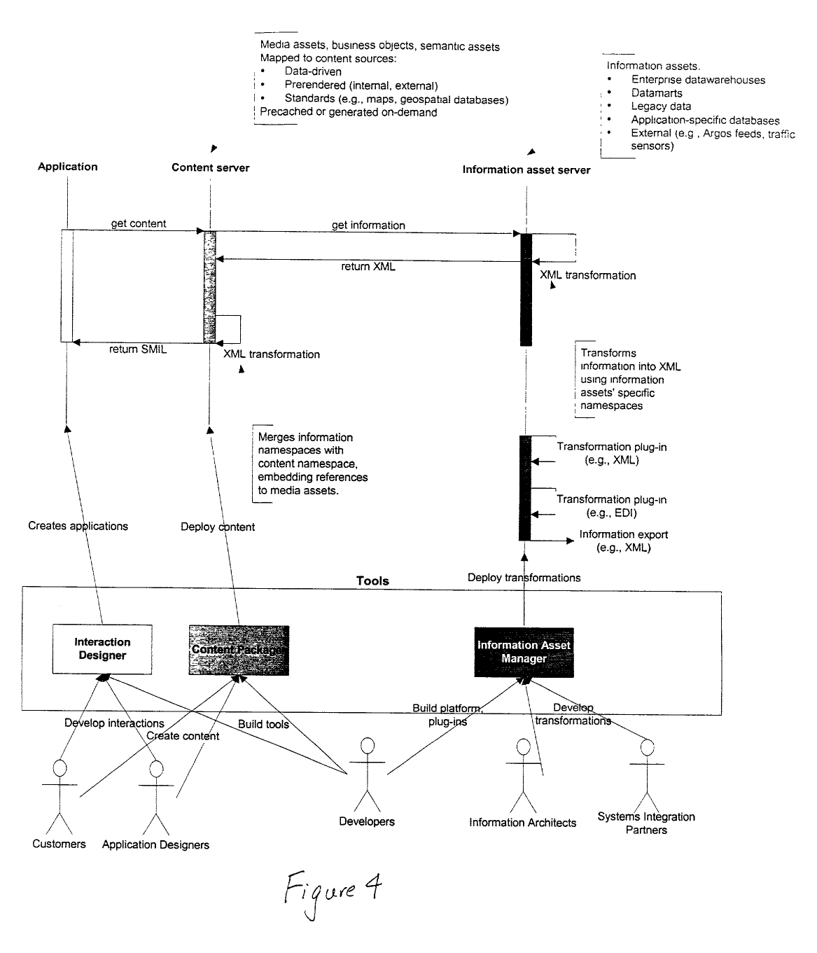

Referring to FIG. 3 to illustrate additional aspects of the present invention, the flow according to the present invention is provided relative to each tier illustrated in FIG. 1. The top bar illustrates the interactions of the tiers for a first user. The next bar illustrates a second user interacting with the same application “A” as the first user, as in an e-collaboration context. Thus, the second user would see a presentation identical to that seen by the first user. The third bar illustrates a third user employing a second application that uses the same content as is being used in application A. The third user receives the same content, although the layout or presentation may differ from that of the first two users. The fourth bar illustrates a fourth user employing the same data as the other three users, but employing different content from that of the other three users. Thus, the fourth user may see different content rendering and layouts and receive different information within different regions of the visual interaction client than the first three users.

Developing and Deploying nTierActive (TM) Applications

Developing an nTierActive (TM) application consists of creating or configuring one or more components in each of the infrastructure's tiers, as illustrated in FIG. 4. Systems integrators, partners, or production staff may fill these development roles:

Information Architect

An information architect (IA) creates and deploys information assets. First, the IA defines an intermediate XML format for each external data source, using an existing standard (if available), an ad hoc format, or a custom format. Then, the IA builds transformations or maps for each external data sources (e.g., partner's enterprise data, legacy data, standard data) into the intermediate XML format. The transformations may run once, storing the XML in the nTierActive (TM) repository or externally. Or the transformations may run on a scheduled or on-demand basis.

The IA will also transform the XML representing user interaction events into a format that a partner's system can use.

Content Manager

A content manager creates and deploys content assets to manage information assets and related media assets. The content assets will consist primarily of XML transformations and references to media files or graphics generators. Advanced projects may require the content manager to integrate a partner's content management system or media asset management system with the nTierActive (TM) content asset tier.

Interaction Designer

An interaction designer creates application templates, which define user interaction styles and layout regions for a class of applications.

Application Designer

An application designer performs the final integration step by assigning content assets to application templates' placeholders. After the pieces are in place, the application designer will deploy the application first to the staging environment, for system testing and user approval, and then to the production environment for release to end users.

Typically, nTierActive (TM) application development will follow one of these scenarios:

Custom Development Scenario

The interaction designer creates a custom application template, from scratch or, more likely, cloned from an existing template. The application designer populates the application template with content assets

Wizard-Based Scenario

The interaction designer creates or reuses an Application Design Wizard for a given application template. The application designer uses the wizard to assign content assets to the application.

Numerous variations of the examples and development tools relating to nTierActive (TM) architecture will be apparent to persons familiar with client/server architecture and programming in view of the present disclosure. For example, the present invention encompasses development tools that can automate more of the processes, relieve some of the development roles of their specialist requirements, and give application designers access to more advanced interaction templates.

Application Examples

An example of an nTierActive (TM) application class below illustrates the development process.

Visual Result Set Browser

Referring to FIG. 2, a Visual Result Set Browser applies the nTierActive infrastructure to the common problem of presenting a set of complex products or services to a user in an interactive, intuitive fashion. The layout is simple, while still allowing the user to navigate through a large amount of information. A hero shot portion of the browser provides an image, key feature, and thumbnails according to a particular template. More details relating to the display of a visual interaction client is disclosed in co-pending U.S. patent application Ser. No. 09/553,440, filed Apr. 19, 2000, entitled “Method and Apparatus for Dynamically Generating Enabled Electronic Content.”

Examples of applications that may employ the architecture disclosed herein include: enterprise-to-enterprise or business-to-business collaboration, which will be referred to herein as E2E collaboration, including conference application; B2b e-commerce including sales support, indirect channel support, e-selling, e-procurement, strategic procurement, job costing, and a product configurator; visual search results; disseminating technical specifications or manuals; e-leaming; interactive brochures or brochureware; e-reporting; customer relations management (eCRM); geospatial information; process visualization; and customizable front-ends.

E2E Collaboration

Because the architecture disclosed herein is able to dynamically update the state of a client's session and because the new middle tier is separated out into application manager, content assets, and information assets, the new architecture allows collaborative interactions at any level of the architecture. These collaborative interactions may be among users of the same application, among users of different applications based on the same content assets, or among users of applications based on different content assets that are in turn based on the same information assets. Briefly, the architecture enables and corresponding methods enable collaboration such that there may be more than one user, and one user's actions may affect other users' experiences. As an example, there would be one person who is running a presentation and the viewer of that presentation then sees the slides change or the step of the presentation change (as in the second bar of FIG. 3). For details of the generation and presentation of information in a browser environment, refer to co-pending U.S. patent application Ser. No. 09/553,440.

Another kind of collaboration could be between users running different applications deriving content form the same content source (as in the third bar of FIG. 3), so they might concurrently see that the sales forecast in one application is represented as a pie chart but in another is represented as a bar chart, and the user drags or clicks on a wedge of a pie chart that corresponds to some category of the sales (or changes the magnitude of the data underlying the pie chart) and the other user sees that change in the bar chart they are viewing.

A third kind of interaction could be between different applications that use different content assets or that are driven off the same information asset so that a change of that information asset, either (for example) based on the user action or an external event, bubbles up through a content source change to an application that is changed on-the-fly. Other architectures do not allow for such a on-the-fly interaction in the same way. The architecture of the present invention is unique in its ability to decouple the tiers of the application as bi-directional XML streams and distribute the interactions across those streams. Relatedly, in the context of a help desk application or a call center application, a company representative would have an email link. The representative could email this interactive visual business environment according to the present invention to the person who needs help. The caller could open it and the two environments would be synched.

Conference Application In a conference application context, a presenter can control the whole navigation of the presentation and participants may register, sign in, passively navigate, and annotate. However, the participants are not controlling anyone else's view. There are viewers who can passively navigate although they can only move forward up to the current point. Spectators can only watch the different views or classes.

Sales Support

Sales support could mean an assisted selling process in addition to an unassisted selling process. Sales support includes providing a directed sales presentation that leads to a custom proposal or custom quote for a particular customer of the presenter. The invention or an application built on the invention allows the management to evaluate sales effectiveness by looking at the user interaction events that have occurred during a sales presentation to create useful analyses. As an example, the invention enables comparison of the close rate when sales people skip an opening architecture slide or the information about history of the partner company whose content is displayed at the client compared with when sales people go through the first step. Thus, conclusions may be drawn regarding the effectiveness of the material or the enthusiasm of the sales people for various portions of the material.

The information output could also be out of the information asset layer where information assets are defined. This may be, for example, a quote for a customer that is created and then gets transformed into a format, such as XML, that can get transmitted to another system for use therein. That data can be pulled from a legacy system or pushed to it using EDI, XML, or other suitable data integration language or the like.

Indirect Channel Support

In an indirect product distribution channel situation (such as a value added reseller (“VAR”) or a channel or distributor with low value added), the value added typically is the reach of the product information rather than the richness provided to the process or information thereby. The original source of the product, such as the manufacturer of the product, owns the knowledge or expertise in how to merchandise their product and what information to show about it. In such a circumstance, the original source typically controls the content even though it gets presented by way of the indirect channel.

A particular distribution channel participant typically wants to own and control the customer relationship and be able to manage and benefit from the branding of the user experience. A conventional approach may be to require a push out of media assets for a particular product—such that here is the thumb nail picture, here is the detailed picture, here are the specifications, here are the key selling features, Then the indirect channel, the VAR for example, has to incorporate those items into their website. Instead, according to the invention, the original manufacturer may push through a chunk of the experience which then may be automatically built into or incorporated into the whole total experience that can be controlled or managed by the channel participant. Thus, the present invention enables any user to establish multiple information relationships with sources of supply whose supply of content will be transmitted to the visual business environment (or the interactive medium for the end user experience) to support sales efforts. The party controlling the experience is therefore the middleman in the indirect channel, not the end user or the manufacturer. In this particular discrete application, it is the indirect channel that is controlling the branded experience. As in other examples of particular applications described herein that may employ the present architecture, there are numerous variations of the control of various aspects of the experience (in this case, control of the branding experience), as will be clear to persons familiar with conventional client/server architecture and/or e-commerce systems or methods on view of the present disclosure.

Thus, a business that employs the invention to design an interactive medium for the end user experience that pulls content from its relationships is enabled by the invention so that users will be able to have updated data from various sources of supply and will benefit from the flexibility of on-the-fly and data-driven advantages of the invention.

e-Selling/e-Procurement

One of the concepts related to e-selling similar to the indirect channel support application is the manner in which a vendor or manufacture would want to present merchandise relating to certain products to potential customers. Also related to e-selling is the concept of cross-selling and up-selling regarding related content. Layered on top of that are the semantics of a particular kind of product that gets an add-on sell. Other kinds of products use a manner of up-sell such that someone who is interested in certain features of a particular model may then be alerted to another model with similar feature that can be sold instead.

E-procurement may be referred to as a separate category from e-selling, because it is the other side of the equation. E-procurement may be a workflow process that is usually a three party model such that is there is requisitioner, a seller, and a buyer. The buyer is not the person who ends up needing the product or service, it is the person who knows what business rules to apply for price and delivery preferred vendors, target volumes, vendors, and/or similar purchasing management criteria. The requisitioner does not necessarily care about those factors. A corporate purchasing department that buys supplies for use by other departments is an example of such a procurement system.

A punch-out presents some of the same issues discussed immediately above. A punch out occurs, for example, when a user is in a buying system and wants to find information and/or do a search for a certain kind of product such that the user's actions takes the user to a vendor site where the searching or navigation may be performed. In the present invention, that process can be mediated and controlled by the seller (including the end-seller, which might be an exchange or distributor, but is not necessarily the merchant or the vendor), in such instance the seller maintaining control over the branding experience and the relationship with customer.

For example, an example of e-selling is where a user on an exchange site who does a request for price and receives a certain set of results back . An example of an e-procurement process is a buyer at a manufacturing facility who is seeking to buy MRO (maintenance and repair operation) supplies, which may include direct and indirect supplies such as light bulbs, janitorial products, a shop work station fan, and like products that would be used in the course of any aspect of the company's operation. The manufacturer buyer typically does not immediately go to the site of a particular merchant (which would be e-selling if the buyer went directly to the merchant), but instead goes to the buyer's intranet, the buying application, where he would begin to create a requisition. One of the items on the requisition would be for something that they think the merchant would sell. That is when the punch-out occurs. Punch-out, in this context, means that the user is going from the buying application to a seller's site. The manufacturer wants to control that process; they want to know about the requisition and all the related information. The merchant's need for this interaction is to still look to the user like the merchant's site, to be able to brand the user experience, and also to get the merchandising and cross-selling opportunities out of the experience. In one instance, for example, the merchant knows that when a buyer is seeking to purchase task lights for production line workers, the merchant would suggest that the buyer might want portable fans too because rules have been established for that particular interaction that reflect the merchant's business knowledge that buyers of such task lights would also be interested in such fans. The invention enables the opportunity for the application and architecture to mediate the commercial interaction by being on either side of the process. In the e-selling application, the application architecture is on merchant's side. In the e-procurement application, the application architecture might be on manufacturer's side such that the architecture takes a feed of XML information from the merchant but it is following manufacturer's rules (that is the buying corporation rules) about how to present that information. The seller's logo may be displayed, for example, to buy under certain conditions such as restricting it to only in a particular spot of the screen such that it would be secondary to the manufacturer's logo, thus providing the buyer an experience in the manufacturer's buying application environment.

Job Costing

Job costing is an application in which visualization is enabled for the particular thing that the user is costing, for example building a new board room, that has temporal steps to it. There may be purchase choices at each step of the process, such as which table to choose and what kind of lighting to choose. According to the present invention, the running cost of the job may be displayed as it is analyzed on an ongoing basis.

Product Configurator

A product configurator employs content that defines that a product or system will consist of particular components having certain options. The user may interact to select the components and options and make some decisions in the flow of their interaction with the application based upon what they selected. The invention encompasses the recording of those events, so that at the end of the process, they have configured a product or system—and an application manager can be configured to save it.

An example of that is an aquarium, the schematic for which defines the visual interaction as the primary navigation element. Thus, as a user moves a mouse over the pump, there is a directed process, such as a directive to select related information, because some of those are dependencies such that, as the user moves his mouse over the pump, there may be a visual indication that such product may be out of out of order and such should be taken into account in the configuration of the aquarium. Alternatively, the directed process may review what the user has viewed such that the schematic will highlight the step that the user is currently on. Additionally, another layout region of the application shows that for the current step, there are particular future choices that may be constrained by previous choices made by the user. Additionally, a user's future interactive choices of information assets could be inferred from their array of past choices and certain information assets likely to be selected could be pre-cached to enhance the speed and quality of the user experience.

In part of the e-selling process or e-procuring process, a variation of the configurator scheme may be employed to do side-by-side product comparisons. Upon presentation of a product and a determination of how to display its key features and benefits, two products may be placed side-by-side and one visual business environment (or the interactive medium for the end user experience) may be provided that synchronizes those two sets of product information for comparison between them. For example, the user could create a data-driven environment on the fly of the search results of two pumps. The specifications may be driven to another quadrant of the client-side interaction so that the user may view them side-by-side and comparison-shop with data while retaining such comparability. In one particular instance, the user would have a filmstrip-type layout of the search results.

Visual Search Results

An external system can push to the architecture a set of content assets that represent the results of a previous user action. The results can then drive architecture to create in the player a search result set relating to particular information that can be represented visually. An example is a set of products originating from an exchange site or a B2B commerce site.

Interactive Content Distribution

In this instance, multiple users may employ the invention to view current related content, such as an array of related products in interactive brochureware or technical specifications related to a particular product, which would automatically be up to date and easily updateable because such content is derived from the architecture's information assets, according to the present invention. This can also be driven off of the visual interaction where the user is looking at a product and wants to see, for example, the current technical specifications placed directly in context.

Displaying related technical specifications is a specific use of the ability of the player to have related content displayed. What makes displaying technical specifications a specific use is that the content that comes down into the player that represents a particular product or system is going to have in it enough information and data that it is possible to tell the information manager that the technical specifications are for the discrete product in the context of a particular user, for instance, it being known from the current interaction that such user already has a particular version of the technical specifications currently cached and it does not need to be updated yet. Thus, the invention as employed to display technical specifications is not a dumb link, but rather is actively updateable.

eLearning

eLearning is a directed presentation process with branches of potential user interactions where the presentation flow is based on user actions in the current and past sessions. The rules may invoke methods of managing the eLearning experience and process, which may be self-paced or unassisted. There are instructional media assets that the user is interacting with and logic to not only control the branching of it, but also to record the actions of the user and anticipate uses of, and navigation through, the process.

e-Reporting

In eReporting, aspects of the invention may create a report in a graphical format, or in a way that employs graphic features, all in a way the user can interact. According to the invention, the graphical portion of the information can be represented by generating the graphs as SVG (scalable vector graphics), which has the advantage of being scalable (i.e. may be enlarged and yet still retain high resolution), easy to download, and is high resolution. Further, an important advantage is that semantics may be automatically inserted into such information, which semantics may include the hot spotting of a particular portion of a pie or stacked bar chart. Each segment of the stacked bar can be a separate hot spot with additional XML information embedded therein about what that segment means or relates to. A click through or mouse over and interaction with it tells the application what to do with that event. Thus, in such reports, user interactions can be more easily facilitated by this aspect of the invention.

Customer Relations Management (eCRM)

Customer relations management broadly includes interactive brochureware, indirect channel support, technical specification dissemination, and similar applications. In addition, it can relate to customer care and customer support after the sale. For example, in an application directed primarily to call-center representatives, it should be noted that in the pharmaceutical industry there is a normally a need for a call-center representative to have a physical sample of a package for each of the company's products because the representative may direct the caller (or the caller may direct the call center representative) to a particular portion of the package, including the bottom, a side, and the top and be asked to provide or observe certain information from such areas.

According to the present invention, a visual may be provided that enables product drill down and the retrieving of a visual representation of the product packaging or product itself on the screen. The visual interaction may guide the call center representative through the process in instructing the caller what to do, for example, telling the caller to turn the package to expose lot number information. The representative can click on a predetermined portion of the screen to turn the picture on the screen and it can circle or highlight in some way the lot number. The representative can type in the pertinent caller information, and this information (such as the caller's complaints and related feedback), as well as other events, may be captured.

Cross Enterprise Workflow Visualization

The uses of the invention to enable a visualization of workflow across an enterprise would be varied. One example would be in aircraft engine repair. A user would check-in an engine to be repaired, highlighting the reported problems, then the owner of that business or its customers can use this application to see the status of the repair of each of those parts by mousing over the part. This could be process visualization such that the reporting status is through the application as well.

Geospatial Information

Some data has a geospatial component to it, which means is that it has something that ties a piece of data or a dimension of the data to a geographic or spatial location. The data might have the GPS information fitted or embedded therein, such as zip code, or other reference to a particular location on a map. The data may be spatial such that it pinpoints where products are located, for example, in a particular warehouse or on a shelf in that warehouse. Upon receiving such information, a set of vector graphics that represent the background map may be automatically overlaid in a way that also can have some meaning to it. For example, a red dot may indicate warehouses that are out of product, and a mouse over can give you the details of such status.

For example, in circumstances in which a user wants to find a certain kind of modular space unit to rent, a user may have a preference to find space that is near her. She would start by drilling through a map to find a branch office nearby that rents space. If she wants a modular unit, but that branch is sold out or she does not like the specifics of that branch, then, employing the present invention, she could be taken to a map that would show her all the other locations that have that modular space unit, which could be indicated by (for example) a blue dot.

Another example of a geospatial applications would include a set of national links that shows a map of the United States where the user can access data underlying the visual representation of a particular region to see the discrete activities of the various components of the business, project or activity generated on-the-fly. Examples would include product sales by particular regions or the current polling results for an election.

Process Visualization

Process visualization includes any process (such as a commercial or manufacturing process) that a business can describe in a way that can be represented as visual experience. The process may be entirely contained within an enterprise or may be an E2E process. For example, a supply chain process may include a chemical company that produces a raw chemical that they then sell to an outside company or terminal. The outside company may further refine or process the raw chemical and then sell it back to the original chemical company, which then packages it for sale as a finished product. To be able to visualize the finished steps of the process, according to the present invention, the user may see discrete stages of the processing and shipping process, any quantity sold and unsold or the status of production of a particular chemical, and thus project the availability of the product. The visualization might derive, on-the-fly, the desired information and media assets from an existing legacy system that tracks the process.

The advantage of such a visualization is obtained not only by people inside the original company, but also at the terminal and manufactures representatives downstream of processing, which may not currently be accessing the existing legacy application in an efficient and non-resource intensive way. Thus, the process visualization will enable the sharing of information in a more effective and easily accessible way, across and along a wider base among customers, users, and related entities.

In a case where companies don't yet have an application that follows the above process all the way through its stages, the present invention can provide such information by gathering and building the information and content assets that represent it and then efficiently pushing those assets out such that cross enterprise boundaries link information together in a way that actually is the supply chain representation itself.

For example, a flow chart showing the process steps may be represented in a simple graphical kind of format. A chemical type or a customer according to selected data filter criteria may be displayed. Each step of the process can be color coded or given some kind of iconic representation. A mouse-over of each step can show details, such as the quantity in the particular stage, the quantity projected to be done at that stage, and the like. The flow chart and related visualization be generated either as a total system that gathers the data or from legacy data as it would be updated on-the-fly.

Customizable Front-End

Generically, a customizable front end is the empty container, which may be manipulated using a graphical building interface known as a Wizard, as mentioned above. The container may be a cacheable or an installable container generating a new application each time a user accesses it. That container need not be replaced, it is just a point of content. The parameters of customization of the container as defined are such that it is not just an empty shell into which a user can just stick anything, but instead that a user who employs the container according to the present invention can obtain various sets of the functionalities of that particular type of container, including the linking of content to other content, hot spotting, and the like, as described herein

Templates may be provided to enable a user designing his customizable front-end. For example, one template may be as shown in FIG. 2 and another template may be a filmstrip-type. Further, a user may design their own interaction templates and then write Wizards for those if the user wants power users to use them within particular parameters. For example, a user may customize the layout, determine where the regions of the screen are, determine what can go in the regions, and their use. A user may customize the flow of the application. Flow is what goes in what region at what time and what events trigger a change in the application states. Thus, if the application may be described as a series of states where the state is defined by the particular media asset, the region, and anything that is playing is a played piece, then the application is a series of state transitions that are triggered by events. The events can be time, user action, notification from the application manager server, or a media event like a video is done playing. Thus, this is an example of what constitutes the front-end and of course, what media assets go in there. The user perceives the media assets and the set of requested functionalities as part of the container.

For examples, a company logo may be displayed on the upper left of the container. The logo, the interaction buttons, frames, bevels, and other widgets of the skin can be customized based on what the application is and/or what site it was launched from. A company might merchandise its products through the present invention by defining a standard way to present their product for features and benefits, and to show what to highlight, but the presentation of that interaction will depend on whether they will syndicate links to that user to various sites and the look of that interaction session will depend on the site the container was launched from.

The nTierActive (TM) infrastructure of the present invention is thus a step toward an open, standards-based architecture for creating and deploying new classes of E2E applications. Examples or embodiments of the inventive concepts are described herein. For example, portions of the description herein disclose the employing of XML, JAVA, SMIL and modifications thereof (and the like) for various tasks, employing a browserbased client, and deploying data assets in particular tiers. The present invention, however, is not limited to the particular examples or embodiments disclosed herein. Rather, the present invention encompasses the broad inventive concepts disclosed herein including numerous variations of the particular examples or embodiments. Other versions may employ Java 2 and run on pervasive computing platforms such as handheld portable computing devices and set top boxes, and will incorporate other media types, such as moving video and like media types.

1. A multi-tier architecture for presenting visual information to multiple displays through a network, the architecture comprising:
an information asset tier including information asset information;
a content asset tier including content assets that includes at least one of media assets and business rules, the media assets including at least one of graphical images or links thereto, the business rules including rules governing the presentation of media assets; and
an application tier including an application that is at least one of an interaction style, a layout template, and a set of rules governing event reporting and interaction with a client, the application generating references to content assets, interfacing with the client to receive events therefrom, recording or responding to the events, and performing actions on said events,
whereby the application, content assets, and information asset information may substantially simultaneously be used by multiple clients and the.

2. The multi-tier architecture of claim 1 wherein the information asset information includes mapping or transformations of information assets from at least one data source.

3. The multi-tier architecture of claim 1 wherein the media assets include images, text, and data.

4. The multi-tier architecture of claim 1 wherein the content assets include enterprise semantics that provide predetermined specific meaning to the content assets based on the information assets.

5. The multi-tier architecture of claim 1 wherein the actions performed on the events include at least one of updating the application, content assets, or information assets and publishing the events to the client.

6. The multi-tier architecture of claim 2 wherein data of the data source itself defines predetermined mapping or transformations, wherein the mapping or transformation includes at least one of object oriented code or XML code.

7. The multi-tier architecture of claim 2 wherein the data source includes at least one of a data feed, standards data, or a static document.

8. The multi-tier architecture of claim 7 wherein the static document is mapped legacy data in XML format.

9. The multi-tier architecture of claim 1 wherein the media assets include pre-rendered image files or images that are generated on demand.

10. A visual interaction client that is launched in response to a user's input and that interacts with an application manager that includes a layout template and a set of application rules governing event reporting and interaction with the client, the application manager generating references to content assets, the application manager interacting with a content asset that includes media assets, business rules, and enterprise semantics, and the content assets interacting with information assets that define mapping or transformations of a raw data source; whereby the application, content assets, and information assets may substantially simultaneously be published to multiple visual interaction client.

11. The visual interaction client of claim 10 wherein the application interfaces with the client to receive events therefrom, records or responds to the events, and acts on the events, whereby such acts include updating the application, content assets, or information assets to publish the events to the client and anticipating the future activities of the user within the visual interaction client by observing the past user interactions and speeding the user experience by pre-caching anticipated media assets.

12. A method for dynamically generating content for providing an interactive visual display to a user, comprising the steps of:
(a) providing a partner's predetermined information assets to a content manager in response to a user input;
(b) matching by the content manager of the information assets of step (a) to corresponding media assets according to interaction rules that are predetermined by the partner;
(c) providing content manager output of step (b) to an application manager;
(d) generating in the application manager an application manager output from the content manager output according to the interaction rules, the application manager handling events from the client and responding to the events;
(e) publishing the application manager output to a client; and
whereby the content manager, asset manager, and client are decoupled.

13. The method of claim 12 further comprising the step of providing a template for displaying the application manager output.

14. The method of claim 12 wherein the application manager receives and interprets the events from the client and instructs an information asset manager to perform the providing step (a).
